(19) United States
(12) Patent Application Publication
(10) Pub. No.: US 2018/0123122 A1
(43) Pub. Date: May 3, 2018

(54) METHOD OF PREPARING LITHIUM ION BATTERY ELECTRODE HAVING MICRO-PATHWAYS

(71) Applicant: Nissan North America, Inc., Franklin, TN (US)

(72) Inventors: Ying Liu, Walled Lake, MI (US); Taehee Han, West Bloomfield, MI (US); Yoshitaka Uehara, Novi, MI (US)

(21) Appl. No.: 15/339,636

(22) Filed: Oct. 31, 2016

(51) Int. Cl. H01M 4/139; H01M 10/0525; H01M 4/04; H01M 4/36

(52) U.S. Cl. CPC H01M 4/139; H01M 10/0525; H01M 4/0404; H01M 2004/021; H01M 4/366; H01M 2220/20; H01M 4/0471

(57) ABSTRACT

A method of preparing an electrode for a lithium-ion battery includes coating a slurry of electrode material onto a current collector, penetrating the slurry with rods coated with a polymer that expands when heated and shrinks when cooled, heating the rods coated with polymer while penetrated in the slurry. The polymer expands during heating, and then shrinks when cooled. The cooled rods and the polymer are removed from the slurry, leaving micro-pathways in the slurry where the rods and polymer penetrated.

### TECHNICAL FIELD

This disclosure relates to a method of forming micro-pathways in an electrode for a lithium ion battery.

### BACKGROUND

Hybrid vehicles (HEV) and electric vehicles (EV) use chargeable-dischargeable energy storages. Secondary batteries such as lithium ion batteries are typical energy storages for HEV and EV vehicles. Lithium ion secondary batteries typically use carbon, such as graphite, as the anode electrode. The automotive industry is continually developing means of improving the energy density of these batteries. For example, the use of thicker battery electrodes is being investigated as one means of increasing the battery's energy density. Thicker electrodes pose new challenges, such as difficulty with lithium ion diffusion through the thicker active materials.

### SUMMARY

Disclosed herein are methods of preparing an electrode for a lithium ion battery. One method includes coating a slurry of electrode material onto a current collector, penetrating the slurry with rods coated with a polymer that expands when heated and shrinks when cooled, heating the rods coated with polymer while penetrated in the slurry. The polymer expands during heating, and then shrinks when cooled. The cooled rods and the polymer are removed from the slurry, leaving micro-pathways in the slurry where the rods and polymer penetrated.

Another method of preparing an electrode for a lithium ion battery includes coating a slurry of electrode material onto a current collector, the slurry having a thickness; penetrating the slurry with rods coated with a polymer that expands when heated and shrinks when cooled, the rods uniformly spaced within the slurry and penetrating the slurry greater than 86% of the thickness and less than 100% of the thickness, and the rods having a thermal conductivity of 200 W/m·K or greater. The electrode and rods coated with polymer are heated while penetrated in the slurry to dry the slurry, the polymer expanding during heating. The electrode, the rods and the polymer, are cooled, the polymer shrinking during cooling. The rods and the polymer are removed from the slurry, leaving micro-pathways in the slurry where the rods and polymer penetrated.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a flow diagram of a method of preparing an electrode for a lithium ion battery as disclosed herein.

FIG. 2 is a schematic of a step of the method of FIG. 1 as disclosed herein.

FIG. 3 is a schematic of another step of the method of FIG. 1 as disclosed herein.

FIG. 4 is a schematic of another step of the method of FIG. 1 as disclosed herein.

FIG. 5 is a schematic of another step of the method of FIG. 1 as disclosed herein.

FIG. 6 is a schematic of another step of the method of FIG. 1 as disclosed herein.

### DETAILED DESCRIPTION OF THE EMBODIMENTS

Lithium ion batteries include, for example, electrodes that are porous composites of solid-state active material particles bound together by a conductive carbon-binder mixture, with an ion-conducting liquid electrolyte filling the pores. Rates at which lithium ions are transported through the active material depend on the microscopic structure, or tortuosity, of the composite electrodes. To maximize the energy density of the lithium ion battery, electrodes with low porosity and high thickness are desired, reducing the number of unit cells required in the battery and thereby reducing the inactive components (separator, current collectors). However, electrodes with low porosity have high tortuosity, leading to poor or slow lithium ion transportation. The methods disclosed herein produce thick, dense electrodes with enhanced lithium ion transport, enabling the development of lithium ion batteries with high energy density and high power density.

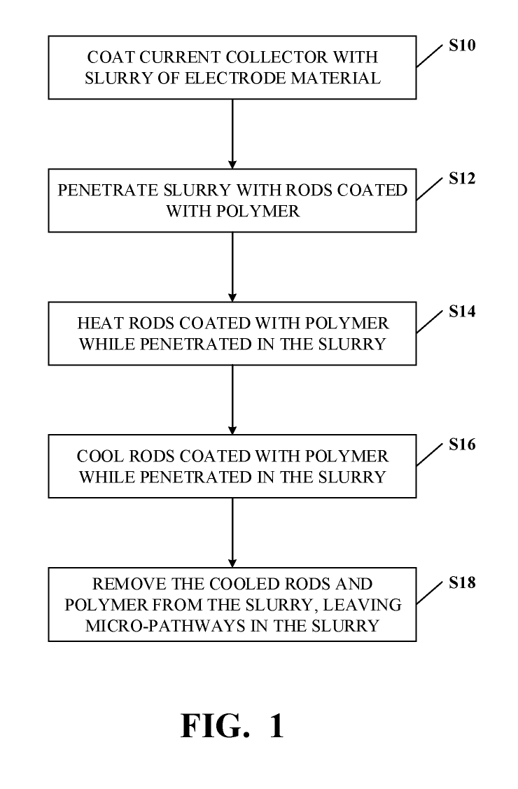

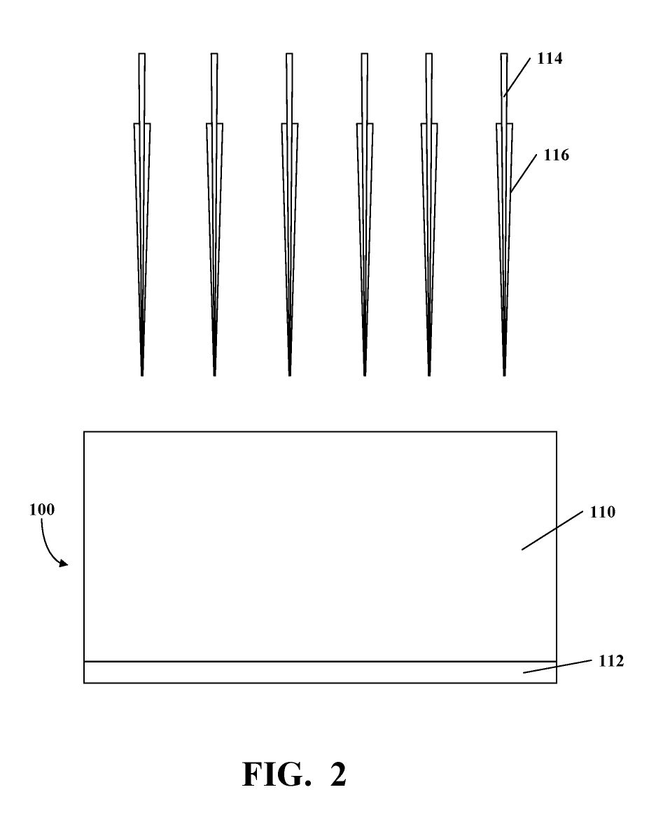

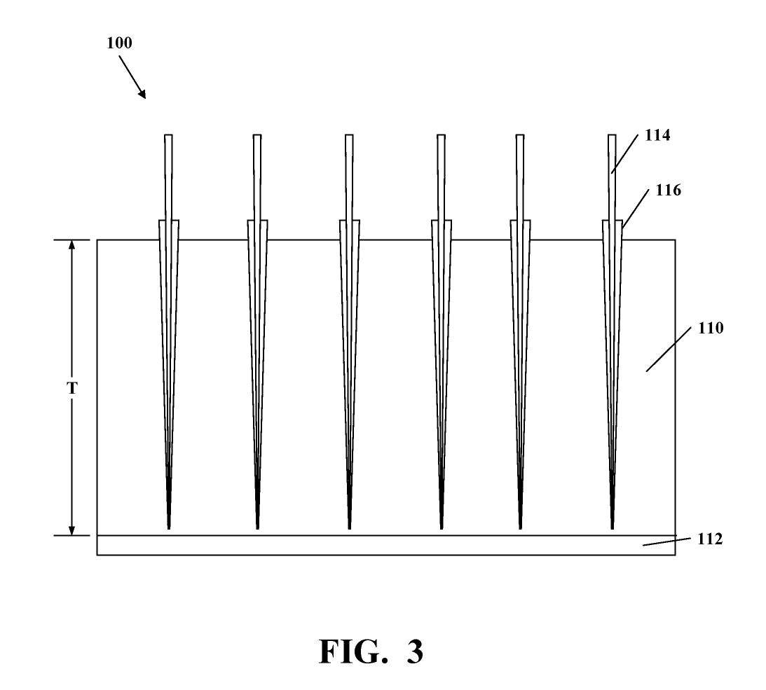

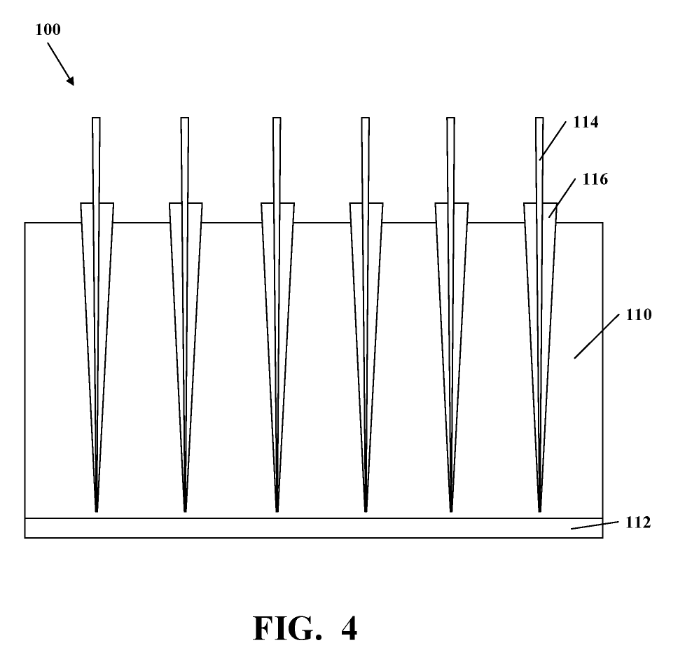

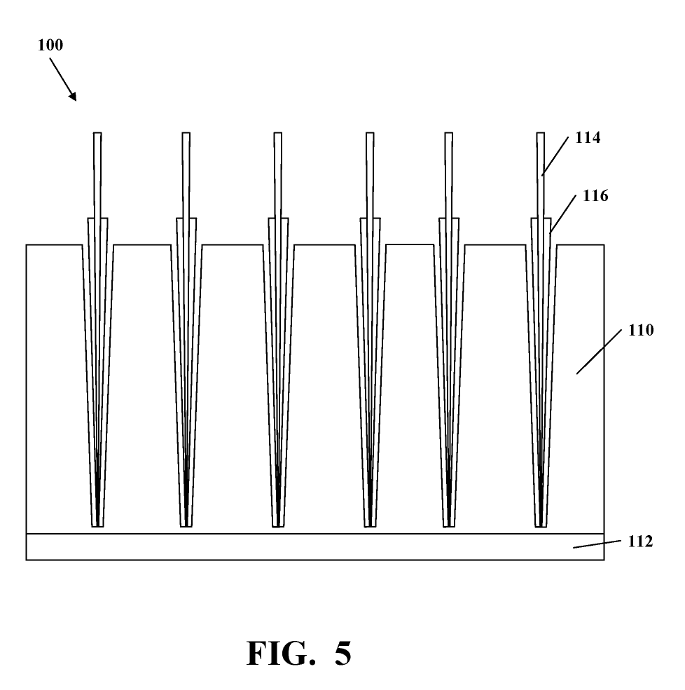

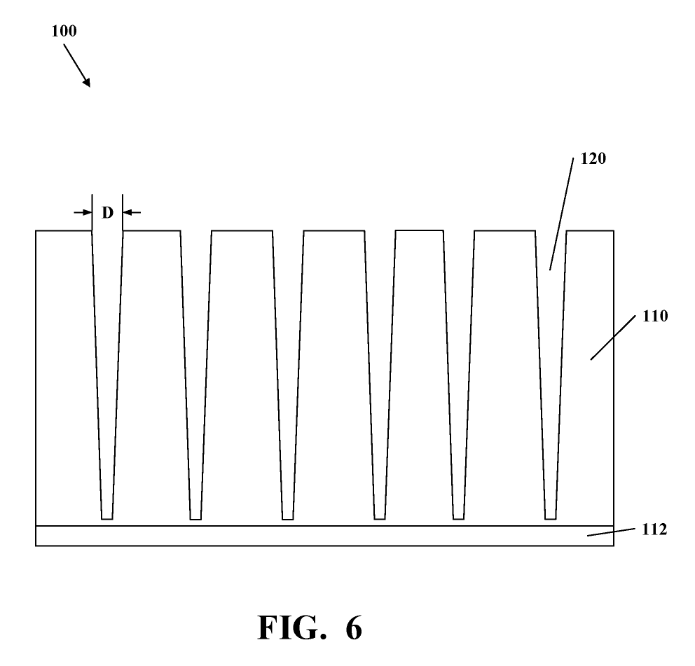

FIG. 1 is a flow diagram of a method of preparing an electrode for a lithium ion battery. FIGS. 2-6 illustrate schematically the method of preparing the electrode 100. In step S10, a slurry 110 of electrode material is coated onto a current collector 112. As shown in FIG. 3, the slurry 110 is penetrated in step S12 with rods 114 coated with a polymer 116 that expands when heated and shrinks when cooled. The rods 114 coated with polymer 116 are heated while penetrated in the slurry 110 in step S14. The polymer 116 expands during heating, as shown in FIG. 4. The rods 114 and polymer 116 are cooled in step S16, shrinking the polymer 116 as shown in FIG. 5. The cooled rods 114 and the polymer 116 are removed from the slurry 110 in step S18, leaving micro-pathways 120 in the slurry 110 where the rods 114 and polymer 116 had penetrated. The micro-pathways 120 are filled with electrolyte, providing pathways for lithium ion transportation through the electrode 100 during use of the lithium ion battery.

The slurry 110 is penetrated with the rods 114 coated with polymer 116 while the slurry 110 is still wet. Puncturing dried electrode material can lead to cracks in the electrode material and delamination of the electrode layer. This cracking and delamination is avoided by penetrating the slurry 110 while wet. Because the slurry 110 is wet, penetration occurs easily. Therefore, the rods 114 can be of any shape and are not required to be tapered or have a pointed end. The rods 114 can be the same diameter along the length of the rods 114, and can be a variety of cross-sectional shapes. The rods 114 shown in the figures are tapered with a pointed end 122 as a non-limiting example. The rods 114 shown in the figures are shaped like needles. The tapered shape may assist in removal of the rods 114 and the shrunken polymer 116.

The rods 114 are a material with a thermal conductivity of 200 W/m·K or greater. As non-limiting examples, the rods 114 can be a metal or ceramic with the required thermal conductivity. The rods 114 can be copper, for example, having a thermal conductivity of 393.5 W/m·K.

The polymer 116 can be any heat shrink polymer, i.e., a polymer that expands when heated and shrinks when cooled. When the slurry 110 is a water-based anode material for a lithium ion battery, the polymer 116 can be hydrophobic. Examples of a hydrophobic polymer include, but are not limited to, polyethylene, polyvinyl chloride and polymethylmethacrylate. When the slurry 110 is an organic solvent-based cathode material for a lithium ion battery, the polymer 116 can be hydrophilic. Examples of a hydrophilic polymer include, but are not limited to, epoxy and polypropylene. More than one polymer 116 can be used to coat the rods 114. The coating of polymer 116 can be thin and uniformly coated on the rods 114 along the portion of the rods 114 that will penetrate the slurry 110.

Each micro-pathway 120 can have a diameter D equal to or greater than 1 μm and less than or equal to 10 μm. The diameter D of the micro-pathway 120 can vary between these along the length of the micro-pathway 120 or can be a consistent diameter D, depending on the shape of the rods 114 used to form the micro-pathways 114. Each rod 114 with the polymer coating 116 will have a diameter less than the resulting diameter of the micro-pathway 120 as the polymer 116 expands when heated. The diameter of the rod 114 with the heated, expanded polymer 116 will therefore be equal to or greater than 1 μm and less than or equal to 10 μm. The rods 114 can all be of the same size and shape or the rods 114 can vary in size and/or shape to create micro-pathways 120 having varying diameters while equal to or greater than 1 μm and less than or equal to 10 μm. The number of rods 114 coated with polymer 116 is selected based on a volume of the slurry 110 and a volume of the micro-pathways 120. A ratio of the volume of the micro-pathways 120 to the volume of the slurry 110 is equal to or greater than 30% and less than or equal to 50%.

The rods 114 are uniformly spaced on a penetration device when penetrating the slurry 110 to create uniformly spaced micro-pathways 120. As a non-limiting example, the distance between the center of two adjacent rods 114 can be between 500 μm and 50 μm. As a non-limiting example, the penetration device can be a device that carries the rods 114 coated with the polymer 116 that is pressed straight down into the slurry 110. The device can also be used to coat the rods 114 with the polymer 116, dipping the rods 114 into the polymer 116 and drying prior to penetration into the slurry 110. The device can also be configured to heat the rods 114 and the polymer 116 while penetrated into the slurry 110. Alternatively, the device can release the rods 114 when penetrated in the slurry 110.

The electrode 100 has a thickness greater than the thickness of a conventional electrode, which is about 70 μm. As a non-limiting example, the slurry 110 is coated onto the current collector 112, with the coating having a thickness T of about 500 μm. As illustrated in FIG. 3, the rods 114 coated with the polymer 116 penetrate the slurry 110 a depth that is less than the thickness T of the slurry 110. Leaving a space between the current collector 112 and the rods 114 prevents puncturing or otherwise damaging the current collector 112 and avoids delamination of the electrode material from the current collector 112. The rods 114 coated with the polymer 116 penetrate the slurry 110 greater than 86% of the thickness T of the slurry 110 and less than 100% of the thickness T of the slurry 110. Penetrating the slurry 110 greater than 86% of the thickness T of the slurry 110 ensures lithium ion transportation through the thick electrode 110. As a non-limiting example, if the slurry 110 has a thickness T of about 500 μm, then the rods 114 coated with the polymer 116 penetrate the slurry 110 to a depth greater than 470 mm and less than 499 mm. In one embodiment, rods 114 coated with the polymer 116 penetrate the slurry 110 greater than 80% of the thickness T of the slurry 110 and less than 99.8% of the thickness T of the slurry 110.

When the rods 114 coated with the polymer 116 are penetrated in the slurry 110 to the desired depth, heating occurs to expand the polymer 116, as shown in FIG. 4. Heating can occur in different ways. The electrode 100 along with the rods 114 and polymer 116 can be heated in an oven or on a hot plate. The polymer 116 expands and the slurry 110 dries during heating. When cooled, the polymer 116 shrinks for easy removal and the electrode material 110 is dry. If the electrode material is a semi-solid electrode material, or gel electrode, that does not require drying prior to use, the rods 114 coated with the polymer 116 can be heated directly to expand the polymer 116 to form the micro-pathways 120, and then cooled for removal.

The words “example” or “exemplary” are used herein to mean serving as an example, instance, or illustration. Any aspect or design described herein as “example' or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A or B, X can include A alone, X can include B alone or X can include both A and B. In addition, the articles “a” and “an” as used in this application and the appended claims should generally be construed to mean “one or more” unless specified otherwise or clear from context to be directed to a singular form.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method of preparing an electrode for a lithium-ion battery, the method comprising:
coating a slurry of electrode material onto a current collector;
penetrating the slurry with rods coated with a polymer that expands when heated and shrinks when cooled;
heating the rods coated with polymer while penetrated in the slurry, the polymer expanding during heating;
cooling the rods and the polymer; and
removing the rods and the polymer from the slurry, leaving micro-pathways in the slurry where the rods and polymer penetrated.

2. The method of claim 1, wherein the rods coated with polymer are heated along with the electrode material, the slurry being dry when the rods and polymer are removed.

3. The method of claim 1, wherein the rods coated with polymer are directly heated without directly heating the electrode material, the slurry remaining wet when the rods and polymer are removed.

4. The method of claim 1, wherein the rods are needle-shaped with a point that penetrates the slurry.

5. The method of claim 1, wherein the rods are uniformly spaced when penetrating the slurry.

6. The method of claim 1, wherein the rods are of a material with a thermal conductivity of 200 W/m·K or greater.

7. The method of claim 1, wherein the electrode material is a water-based anode material and the polymer is hydrophobic.

8. The method of claim 7, wherein the polymer is one of polyethylene, polyvinyl chloride and polymethylmethacrylate.

9. The method of claim 1, wherein the electrode material is an organic solvent-based cathode material and the polymer is hydrophilic.

10. The method of claim 9, wherein the polymer is one of epoxy and polypropylene.

11. The method of claim 1, wherein each micro-pathway is equal to or greater than 1 μm and less than or equal to 10 μm.

12. The method of claim 11, wherein a ratio of a volume of the micro-pathways to a volume of the slurry is between and including 30% to 50%.

13. The method of claim 1, wherein the rods coated with the polymer penetrate the slurry a depth that is less than a thickness of the slurry.

14. The method of claim 1, wherein the slurry has a thickness of about 500 μm and the rods coated with the polymer penetrate the slurry greater than 470 μm and less than 499 μm.

15. The method of claim 1, wherein the rods coated with the polymer penetrate the slurry greater than 86% of a thickness of the slurry and less than 100% of the thickness of the slurry.

16. A method of preparing an electrode for a lithium-ion battery, the method comprising:
coating a slurry of electrode material onto a current collector, the slurry having a thickness;
penetrating the slurry with rods coated with a polymer that expands when heated and shrinks when cooled, the rods uniformly spaced within the slurry and penetrating the slurry greater than 86% of the thickness and less than 100% of the thickness, the rods having a thermal conductivity of 200 W/m·K or greater;
heating the electrode and rods coated with polymer while penetrated in the slurry to dry the slurry, the polymer expanding during heating;
cooling the electrode, the rods and the polymer, the polymer shrinking during cooling; and
removing the rods and the polymer from the slurry, leaving micro-pathways in the slurry where the rods and polymer penetrated.

17. The method of claim 16, wherein the rods are needle-shaped with a point that penetrates the slurry.

18. The method of claim 16, wherein the electrode material is one of a water-based anode material and the polymer is hydrophobic and an organic solvent-based cathode material and the polymer is hydrophilic.

19. The method of claim 16, wherein each micro-pathway is equal to or greater than 1 μm and less than or equal to 10 μm.

20. The method of claim 19, wherein a ratio of a volume of the micro-pathways to a volume of the slurry is between and including 30% to 50%.
